(19) United States
(12) Patent Application Publication
(10) Pub. No.: US 2021/0180645 A1
(43) Pub. Date: Jun. 17, 2021

(54) METHOD FOR MANUFACTURING TUBE BODY USED IN POWER TRANSMISSION SHAFT

(71) Applicant: Hitachi Astemo, Ltd., Ibaraki (JP)

(72) Inventors: Kazuki Ohta, Ibaraki (JP); Kenichi Mori, Ibaraki (JP); Takahiro Nakayama, Ibaraki (JP)

(21) Appl. No.: 17/186,175

(22) Filed: Feb. 26, 2021

Related U.S. Application Data
(63) Continuation of application No. PCT/JP2019/010049, filed on Mar. 12, 2019.

(30) Foreign Application Priority Data
Feb. 27, 2019 (JP) 2019-033777

(51) Int. Cl. F16C 3/02; B29C 70/86

(52) U.S. Cl. CPC F16C 3/026; B29L 2031/75; F16C 2326/06; B29C 70/86

(57) ABSTRACT

A method for manufacturing a tube body made of fiber-reinforced plastic and used in a power transmission shaft is provided and the method includes: a generating step of disposing an uncured fiber-reinforced resin on a cavity surface of a mold and generating a resin body in a cylindrical shape; and a curing step of supplying a fluid inside the resin body and curing the resin of the resin body.

### CROSS-REFERENCE TO RELATED APPLICATION

This application is a PCT Bypass Continuation application of and claims the priority benefit under 35 U.S.C. § 120 to PCT application No. PCT/JP2019/010049, filed on Mar. 12, 2019 and therefore also claims the priority benefit under 35 U.S.C. § 119 of Japanese Patent Application No. 2019-033777 filed on Feb. 27, 2019, the disclosures of all of which (both the PCT application No. PCT/JP2019/010049 and Japanese Patent Application No. 2019-033777) are hereby incorporated in their entireties by reference.

### TECHNICAL FIELD

The present invention relates to a method for manufacturing a tube body used in a power transmission shaft.

### BACKGROUND OF THE INVENTION

A power transmission shaft (propeller shaft) mounted in a vehicle includes a tube body extending in a front-rear direction of the vehicle, and transmits the power generated by an engine and decelerated by a transmission to a final reduction gear by means of the tube body. A tube body used in such a power transmission shaft includes one made of fiber-reinforced plastic. A method for manufacturing a tube body, made of fiber-reinforced plastic and used in a power transmission shaft, for example, includes winding a continuous fiber impregnated with a thermosetting resin around a mandrel in multiple layers to form a cylindrical molded body. Then, the molded body is heated to cure the resin to form a cylindrical tube body. Subsequently, the mandrel is withdrawn from an opening at an end of the cured tube body, to complete the manufacturing process (see Japanese Patent Application Publication No. H03-265738).

### SUMMARY OF THE INVENTION

### Problems to be Solved

Incidentally, with respect to the shape of the tube body, it has been studied in recent years to make the tube body into a so-called barrel shape in which the central portion bulges outward in the radial direction more than both ends. However, when a mandrel in a barrel shape is used to form a tube body of the above shape, the central part of the mandrel bulges outward to inhibit the mandrel from being removed out of the tube body through the opening of the tube body. Therefore, a new manufacturing method that can manufacture a tube body without using any core material (mandrel) is desired

The present invention has been made to solve these problems and is intended to provide a method for manufacturing a tube body used in a power transmission shaft, without using any core material.

### Solution to Problems

A first aspect of the present invention, for solving the aforementioned problems, provides a method for manufacturing a tube body made of fiber-reinforced plastic and used in a power transmission shaft, including: a generating step of disposing an uncured fiber-reinforced resin on a cavity surface of a mold and generating a resin body in a cylindrical shape; and a curing step of supplying a fluid inside the resin body and curing the resin of the resin body.

In addition, a second aspect of the present invention, for solving the aforementioned problems, provides a method for manufacturing a tube body made of fiber-reinforced plastic and used in a power transmission shaft, including: a preparing step of disposing a cylindrical bulging body having a fiber wound therearound in a mold; a bulging step of supplying a fluid into the bulging body to bulge the bulging body; a supplying step of supplying uncured resin within the mold; and a curing step of curing the uncured resin.

### Advantageous Effects of the Invention

According to the present invention, a tube body having a shape to follow the mold is manufactured.

### BRIEF DESCRIPTION OF DRAWINGS

FIG. 1 is a side view of a power transmission shaft;

FIG. 2 is a cross-sectional view of a main body of a tube body used in the power transmission shaft, taken along an axial direction;

FIG. 3 is a flowchart of manufacturing a tube body according to a first embodiment;

FIG. 4 illustrates a preparing step of manufacturing the tube body according to the first embodiment;

FIG. 5 illustrates a generating step of manufacturing the tube body according to the first embodiment;

FIG. 6 illustrates a curing step of manufacturing the tube body according to the first embodiment;

FIG. 7 illustrates a removing step of manufacturing the tube body according to the first embodiment;

FIG. 8 illustrates a curing step of manufacturing a tube body according to a second embodiment;

FIG. 9 illustrates a generating step of manufacturing a tube body according to a third embodiment;

FIG. 10 is a flowchart of manufacturing a tube body according to a fourth embodiment;

FIG. 11 illustrates a preparing step of manufacturing a tube body according to the fourth embodiment; and

FIG. 12 illustrates a supplying step of manufacturing the tube body according to the fourth embodiment.

### EMBODIMENTS OF THE INVENTION

Next, a method for manufacturing a tube body used in a power transmission shaft will be described in embodiments with reference to the drawings. Technical elements common to the embodiments are denoted by common reference numerals and descriptions thereof are omitted. First, a power transmission shaft to be manufactured by the manufacturing methods is described.

<Power Transmission Shaft>

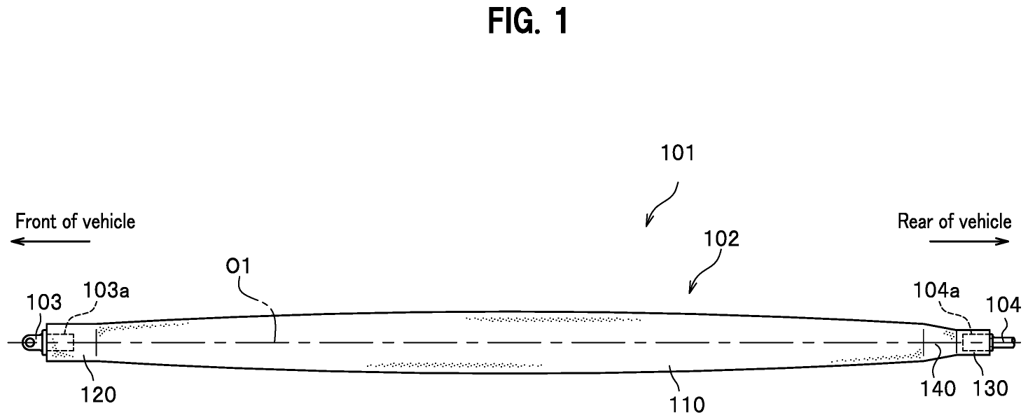

As shown in FIG. 1, a power transmission shaft 101 is a propeller shaft mounted on a front-engine front-drive (FF) based four-wheel drive vehicle. The power transmission shaft 101 includes a tube body 102 in a substantially cylindrical shape extending in a front-rear direction of a vehicle, a stub yoke 103 of a cross shaft joint joined to a front end of the tube body 102, and a stub shaft 104 of a constant velocity joint joined to a rear end of the tube body 102. The stub yoke 103 is a coupling member to couple a transmission mounted at a front of a vehicle body with the tube body 102. The stub shaft 104 is a coupling member to couple a final reduction gear mounted at a rear of the vehicle body with the tube body 102. When power (torque) is transmitted from the transmission, the power transmission shaft 101 rotates about an axis O1 and transmits the power to the final reduction gear.

The tube body 102 is formed of carbon fiber reinforced plastic (CFRP). A fiber layer formed of fibers circumferentially extending about the axis O1 and a fiber layer formed of fibers extending along the axis O1 are stacked inside the tube body 102. This allows the tube body 102 to have high mechanical strength and high elasticity along the axis O1. In addition, a PAN (Polyacrylonitrile) fiber is preferred as a fiber oriented in the circumferential direction, and pitch fibers are preferred as fibers oriented along the axis O1. Note that the fibers used in the fiber-reinforced plastic are not limited to carbon fibers in the present invention, and may be glass fibers or aramid fibers. The tube body 102 includes a main body 110 to make up the majority of the tube body 102, a first connection portion 120 disposed at a front of the main body 110, a second connection portion 130 disposed at a rear of the main body 110, and an inclined portion 140 located between the main body 110 and the second connection portion 130.

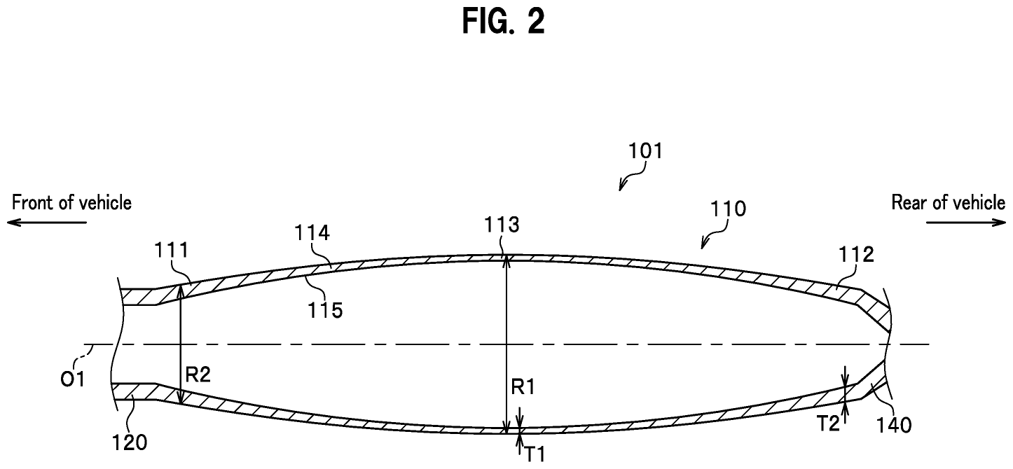

Note that a shape of the tube body 102 is exaggeratedly depicted in FIG. 2 and subsequent figures for the purpose of illustrating a shape of the tube body 102. As shown in FIG. 2, the first connection portion 120 continues to a front end portion 111 of the main body 110, and the inclined portion 140 continues to a rear end portion 112 of the body 110.

When the main body 110 is sectioned in a plane normal to the axis O1, an outer periphery 114 and an inner periphery 115 of the main body 110 each have a cross section in a circular shape. An outer diameter of the main body 110 decreases from a central portion 113 toward both ends (the front end 111 as one end, and the rear end 112 as the other end), and an outer diameter R1 of the central portion 113 is larger than outer diameters R2 of both ends (the front and rear ends 111, 112). Note that an inner diameter of the main body 110 also decreases from the central portion 113 of the main body 110 toward both ends (the front and rear ends 111, 112).

When the main body 110 is sectioned along the axis O1, the outer periphery 114 and inner periphery 115 of the main body 110 each have a cross section gently curved and the central portion 113 protrudes outward in an arc. Accordingly, the outer shape of the main body 110 has a barrel shape, with the central portion 113 bulging radially outward. With respect to the cross-sectional shapes, a plate thickness of the main body 110 decreases from both ends (the front and rear ends 111, 112) toward the central portion 113, and a plate thickness T1 of the central portion 113 is smaller than a plate thickness T2 of both ends (the front and rear ends 111, 112).

As shown in FIG. 1, a shaft portion 103a of the stub yoke 103 is fitted into the first connection portion 120. The outer periphery of the shaft portion 103a is formed in a polygonal shape. The first connection portion 120 has an inner periphery thereof formed in a polygonal shape, to follow the outer periphery of the shaft portion 103a. This configuration prevents the stub yoke 103 and the tube body 102 from rotating relative to each other. A shaft portion 104a of the stub shaft 104 is fitted into the second connection portion 130. The second connection portion 130 has an inner periphery thereof formed in a polygonal shape, to follow the outer periphery of the shaft portion 104a. This configuration prevents the stub shaft 104a and the tube body 2 from rotating relative to each other.

An outer diameter of the inclined portion 140 gradually decreases from the main body 110 toward the first connection portion 120, to have a conical trapezoidal shape. A plate thickness of the inclined portion 140 gradually decreases from an end thereof closer to the second connection portion 130 (rear side) toward an end thereof closer to the main body 110 (front side). This causes the inclined portion 140 to have the smallest plate thickness at a front end thereof as a weak portion. Based on above configuration, if a vehicle is collided from up ahead to have a collision load inputted to the power transmission shaft 101, a shear force acts on the inclined portion 140, which is inclined with respect to the axis O1. If the shear force acting on the inclined portion 140 exceeds a predetermined value, damaged is the front end (weak portion) of the inclined portion 140. This allows the engine and transmission mounted on the front of the vehicle body to be quickly moved rearward, in the event of a vehicle collision, to absorb the collision energy by the front of the vehicle body.

According to the above-described tube body 102, the central portion 113 of the main body 110, where bending stress is likely concentrated, has the outer diameter R1 increased to have a predetermined bending rigidity. In contrast, both ends of the main body 110 (the front and rear ends 111, 112), where bending stresses are less likely concentrated, have the outer diameter R2 decreased so as to be reduced in weight. In addition, the central portion 113 of the main body 110 has the small plate thickness T1 to have a reduced weight. Then, the tube body 102 has the main body 110 reduced in weight while maintaining a predetermined bending rigidity at the central portion 113, to improve the primary bending resonance point of the tube body 102.

### First Embodiment

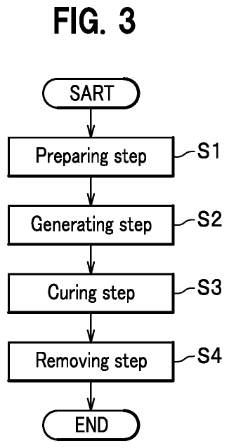

As shown in FIG. 3, a manufacturing method of a first embodiment includes a preparing step (step S1) of disposing an uncured fiber-reinforced resin in a mold 1, a generating step (step S2) of generating a resin body 15 in a cylindrical shape with the mold 1 closed, a curing step (step S3) of heating the resin body 15 so as to be cured, and a removing step (step S4) of removing the tube body 102 used in the power transmission shaft 101 from the mold 1.

<Preparing Step>

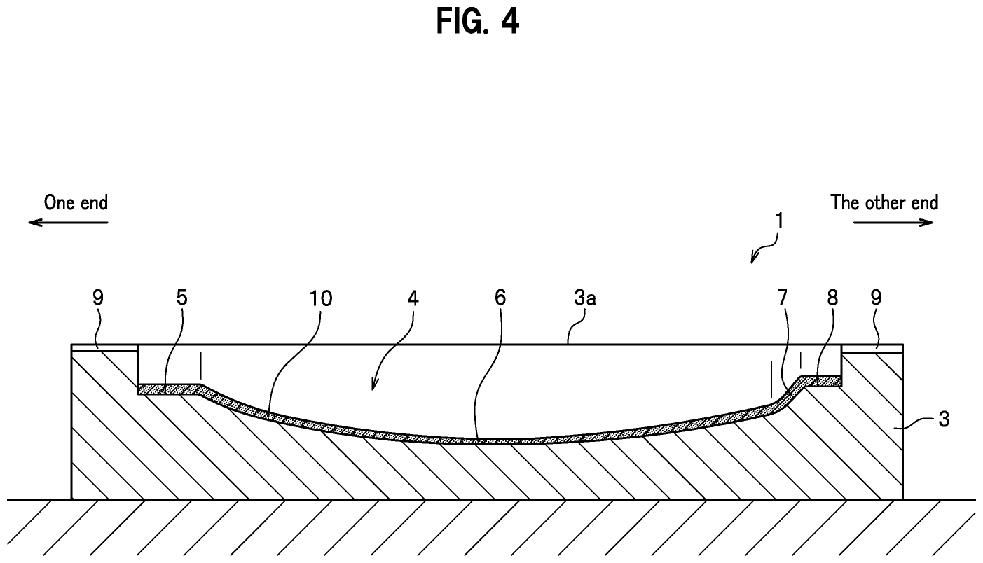

As shown in FIG. 4, the preparing step (step S1) of the first embodiment involves disposing a plurality of prepregs on a cavity surface 4 to dispose fiber-reinforced resin in the mold 1.

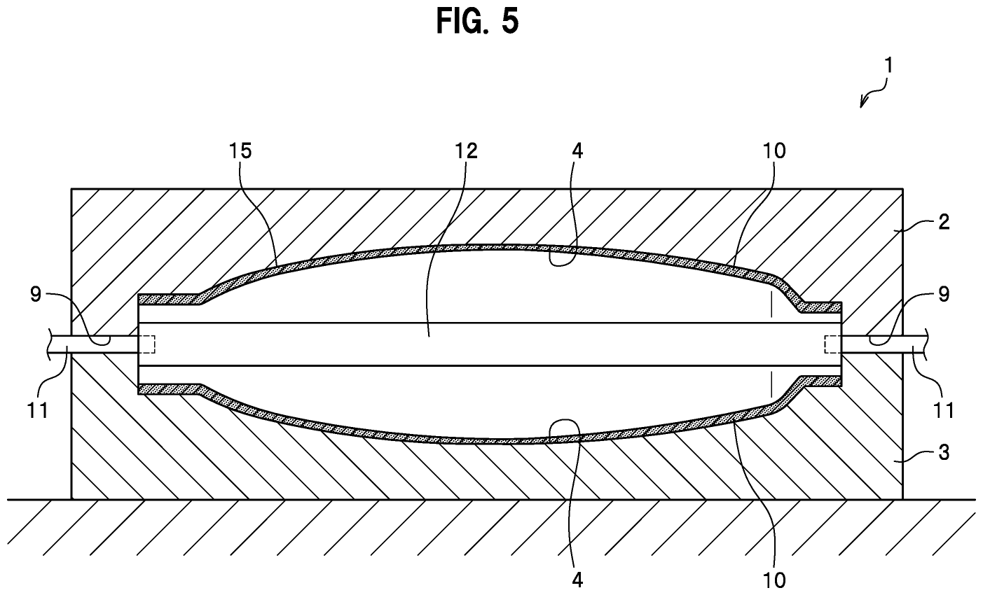

The mold 1 has an upper mold 2 (not shown in FIG. 4, and then see FIG. 5 and subsequent figures) and a lower mold 3. The cavity surface 4 is formed in a lower surface of the upper mold 2 and an upper surface 3a of the lower mold 3 to form an outer shape of the tube body 102. The cavity surface 4 of the first embodiment is elongated in one direction. The cavity surface 4 has, in order from one end in a longitudinal direction thereof toward the other end, a first-connection-portion mold area 5, a main-body mold area 6, an inclined-portion mold area 7, and a second-connection-portion mold area 8. The first-connection-portion mold area 5 is an area to form an outer shape of the first connection portion 120 of the tube body 102. The main-body mold area 6 is an area to form an outer shape of the main body 110. The inclined-portion mold area 7 is an area to form an outer shape of the inclined portion 140. The second-connection-portion mold area 8 is an area to form an outer shape of the second connection part 130.

The lower surface of the upper mold 2 and the upper surface 3a of the lower mold 3 have two communicating holes 9 to communicate the inside of the mold 1 with outside when the mold is tightened. One of the communicating holes 9 is disposed on “one end” side of the first-connection-portion mold area 5, and another is disposed on “the other end” side of the second-connection-portion mold area 8.

A thermosetting resin is used as the resin of the prepreg. Additionally, the thermosetting resin is used in an uncured state. Note that a semi-cured resin may also be used, even with a wording of “an uncured state.” That is, the resin even when cured to some extent can be deformed into a shape along the cavity surface 4 of the mold 1, to allow for being used in a semi-cured state. The prepreg may not be of a size to cover all over the cavity surface 4 alone. In other words, a plurality of prepregs of a size to cover only a part of the cavity surface 4 may be joined together to cover all over the cavity surface 4. Regarding the prepreg, the number of sheets to be disposed is adjusted so as to achieve a predetermined thickness after curing. For example, the prepreg disposed on the main-body mold area 6 is disposed so that the number of layers decreases from both ends in the longitudinal direction toward the central portion, to cause the central portion to have a smaller thickness than both ends. In addition, a mold release agent is applied on the cavity surface 4 in the preparing step, before the prepreg is disposed thereon. Then, according to this step, resin portions 10 in a semi-cylindrical shape are formed on the respective cavity surfaces 4 of the upper mold 2 and lower mold 3, as shown in FIG. 4.

<Generating Step>

As shown in FIG. 5, the generating step (step S2) of the first embodiment disposes supply pipes 11 of a heating device to be described below in the communicating holes 9 of the lower mold 3. Then, a bulging body 12 of the heating device is held to tips of the supply pipes 11 of the heating device, and is positioned above the resin portion 10 in the lower mold 3. Then, the upper mold 2 is superimposed on the lower mold 3, and the mold 1 is closed and fastened to prevent the upper mold 2 from being loosened from the lower mold 3. According to this step, circumferential ends of the resin portion 10 disposed on the cavity surface 4 of the lower mold 3 come into contact with circumferential ends of the resin portion 10 disposed on the cavity surface 4 of the upper mold 2, to generate the resin body 15 in a cylindrical shape. In addition, the bulging body 12 is disposed in the center of the resin body 15.

<Curing Step>

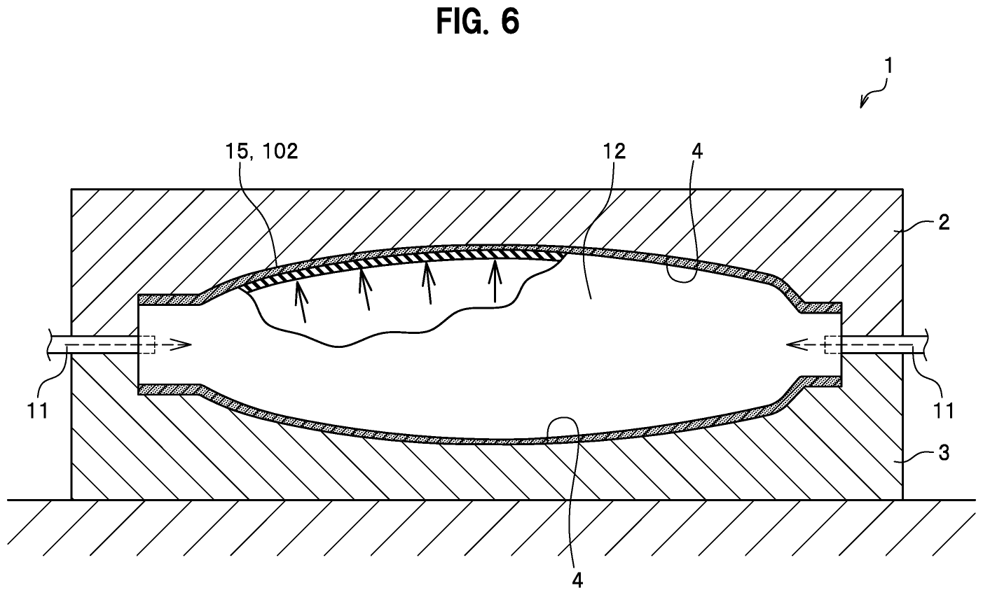

As shown in FIG. 6, the curing step (step S3) of the first embodiment is a step of supplying high-temperature fluid from a heating device via the supply pipe 11 into the bulging body 12 to cure the resin of the resin body 15. The bulging body 12 is an elastic member in a cylindrical shape and bulges in proportion to an amount of fluid flowing thereinto. The elastic member is made of a material having heat resistance to high-temperature fluid, such as silicone rubber, fluoro rubber, or acrylic rubber. Note that the bulging body 12 is sealed at both ends thereof to prevent the fluid supplied through the supply pipe 11 from being leaked. The heating device is a device to generate and supply high-temperature fluid. The fluid supplied in the first embodiment is a liquid. The temperature of the liquid is set to a temperature at which the resin body 15 is cured (e.g., 130° to 180°). The liquid is supplied to the extent that the bulging body 12 bulges to cause an outer periphery of the bulging body 12 to contact an inner periphery of the resin body 15. According to this step, the bulged bulging body 12 contacts the resin body 15, to transmit the temperature of the liquid via the bulging body 12 to the resin body 15, as shown in FIG. 6. As a result, the resin of the resin body 15 is cured to have the power transmission shaft 101.

<Removing Step>

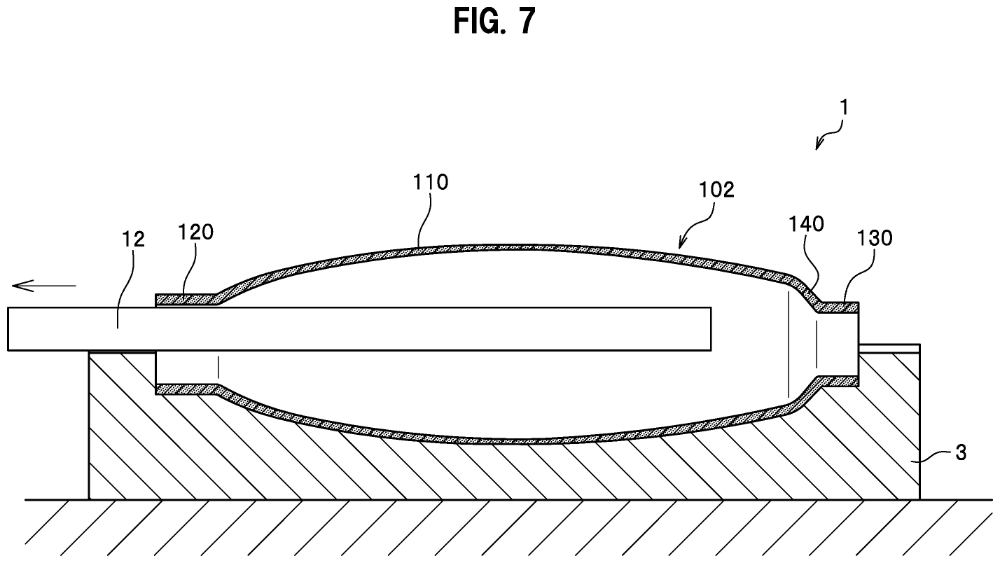

The removing step (step S4) of the first embodiment moves the upper mold 2 to open the mold 1. In addition, the heating device is driven to recover the liquid supplied into the bulging body 12. This causes the bulging body 12 to have the pressure therein reduced to restore an original shape thereof in a cylindrical shape. Next, the supply pipes 11 are removed from the bulging body 12, and the bulging body 12 restored to a cylindrical shape is also removed from the tube body 102 as shown in FIG. 7. As a result, there is nothing to hold the power transmission shaft 101 to allow the tube body 102 to be removed from the lower mold 3.

As described above, according to the first embodiment, the tube body 102 in a so-called barrel shape is manufactured without using any core material.

### Second Embodiment

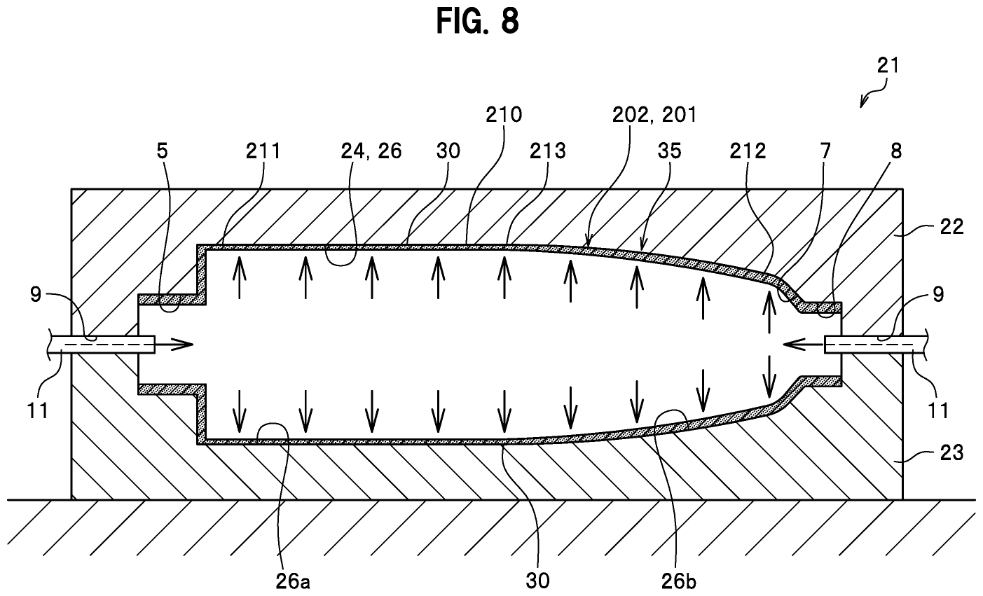

As shown in FIG. 8, a method of a second embodiment for manufacturing a tube body 202 used in a power transmission shaft 201 includes a preparing step (step S1) of disposing a fiber reinforced resin in a mold 21, a generating step (step S2) of closing the mold 21 and generating a resin body 35 in a cylindrical shape, a curing step (step S3) of heating the resin so as to be cured, and a removing step (step S4) of removing the power transmission shaft 201 from the mold 21 (see FIG. 3). Hereinbelow, a description is given, focusing on differences from the first embodiment.

The preparing step (step S1) of the second embodiment forms resin portions 30 in a semi-cylindrical shape, by a hand lay-up technique, on cavity surfaces 24 of an upper mold 22 and a lower mold 23. In other words, fibers are disposed on the cavity surfaces 24 of the mold 21 and an uncured resin (thermosetting resin) is applied to the cavity surfaces 24 to form fiber-reinforced resin (resin portion 30) on the cavity surfaces 24. This hand lay-up technique allows for fine-tuning a thickness of the resin portion 30 formed on the cavity surface 24.

The cavity surface 24 of the mold 21 is formed with the first-connection-portion mold area 5, a main-body mold area 26, the inclined-portion mold area 7, and the second-connection-portion mold area 8. Here, the main-body mold area 26 includes a first surface 26a formed to have a constant diameter from the central portion toward the first-connection-portion mold area 5, and a second surface 26b formed to have a diameter gradually decreasing from the central portion toward the inclined-portion mold area 7. According to the mold 21, the shape of the main body 210 of the tube body 202 is in a shape having a constant diameter from a central portion 213 to a front end 211 and a diameter decreasing from the central portion 213 toward a rear end 212.

In the curing step (step S3) of the second embodiment, the heating device supplies a high-temperature gas via the supply pipe 11. According to the step, the high-temperature gas is supplied into the resin body 35 to cure the resin of the resin body 35. Additionally, in the curing step (step S3), the mold 21 is heated by a heater, not shown, or the like. This allows for heating the resin body 35 from the cavity surface 24 of the mold 21, to shorten a time of heating the resin body 35.

According to the second embodiment, the tube body 202 made of fiber-reinforced plastic is manufactured without using any core material.

### Third Embodiment

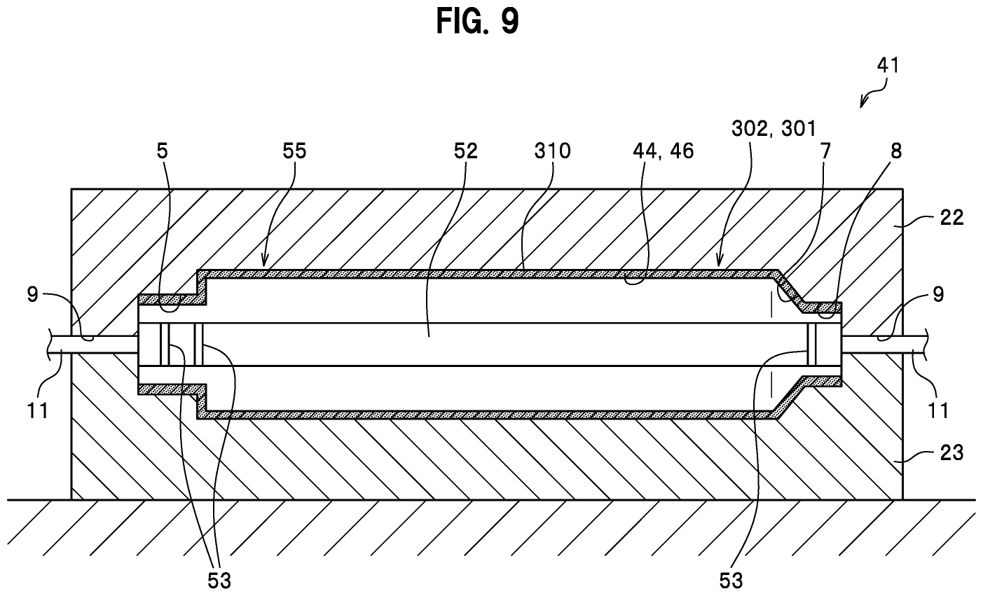

As shown in FIG. 9, a manufacturing method of a third embodiment includes a preparing step (step S1) of disposing fiber-reinforced resin in a mold 41, a generating step (step S2) of closing the mold 41 and generating a resin body 55, a curing step (step S3) of heating the resin so as to be cured, and a removing step (step S4) of removing a tube body 302 from the mold 41 (see FIG. 3). Hereinbelow, a description is given, focusing on differences from the first embodiment.

In the preparing step (step S1) of the third embodiment, a cavity surface 44 of the mold 41 is provided with the first-connection-portion mold area 5, a main-body mold area 46, the inclined-portion mold area 7, and the second-connection-portion mold area 8. The main-body mold area 46 has a constant diameter from one end (first-connection-portion mold area 5) to the other end (inclined-portion mold area 7). The mold 41 allows for manufacturing the tube body 302 having a main body 310 in a cylindrical shape formed with a constant diameter.

A bulging body 52 of the third embodiment has annular members 53 wound around on an outer periphery thereof, at ends in a longitudinal direction thereof. The annular member 53 is formed of an elastic material such as silicone rubber, fluoro rubber, and acrylic rubber. This causes the bulging body 52, when bulged, to be less bulged at the ends than at the center portion. Accordingly, the resin of the resin body 55 on the first-connection-portion molding area 5 and the second-connection-portion molding area 8 is prevented from being pressed more than necessary by the bulging body 52 to flow to other molding areas.

### Fourth Embodiment

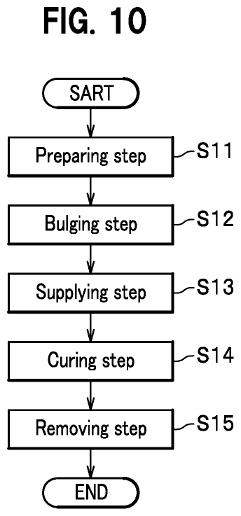

As shown in FIG. 10, a manufacturing method of a fourth embodiment includes a preparing step (step S11) of disposing a bulging body 72 having a fiber 71 wound therearound in a mold 61, a bulging step (step S12) of supplying fluid into the bulging body 72 and bulging the bulging body 72, a supplying step (step S13) of supplying uncured resin into the mold 61, a curing step (step S14) of curing the uncured resin, and a removing step (step S15) of removing the tube body 102 from the mold 61.

<Preparing Step>

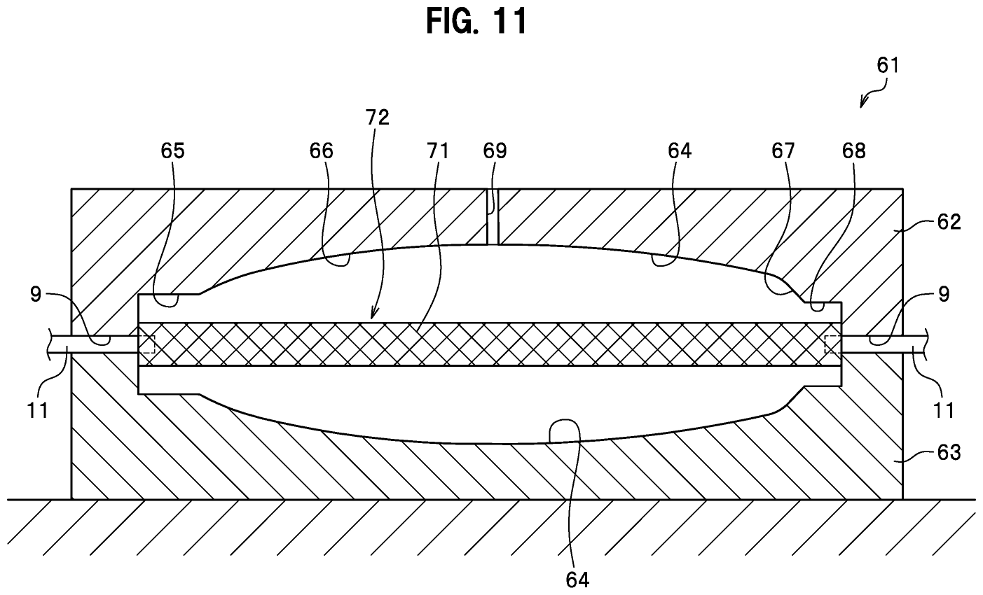

The preparing step (step S11) prepares the mold 61. As shown in FIG. 11, the mold 61 has an upper mold 62 and a lower mold 63. Cavity surfaces 64 of the upper mold 62 and lower mold 63 each have, in order from one end in the longitudinal direction thereof toward the other end, a first-connection-portion mold area 65, a main-body mold area 66, an inclined-portion mold area 67, and a second-connection-portion mold area 68, as with the mold 1 described in the first embodiment. The mold 61 is also formed with communicating holes 9 penetrated by the supply pipes 11 and a spool 69 to supply resin into the mold 61.

The bulging body 72 is of the same structure as the bulging body 12 described in the first embodiment. The fiber 71 is used to reinforce strength of the tube body 102, and may be a carbon fiber, a glass fiber, or an aramid fiber. Note that a technique of winding the fiber 71 and orientation of the fiber 71 are not particularly limited. The bulging body 72 is arranged so as to be held to the tips of the supply pipes 11 having penetrated the communicating holes 9. Accordingly, the bulging body 72 is fixed in the mold 61 so as to be separated from the cavity surfaces 64.

<Bulging Step>

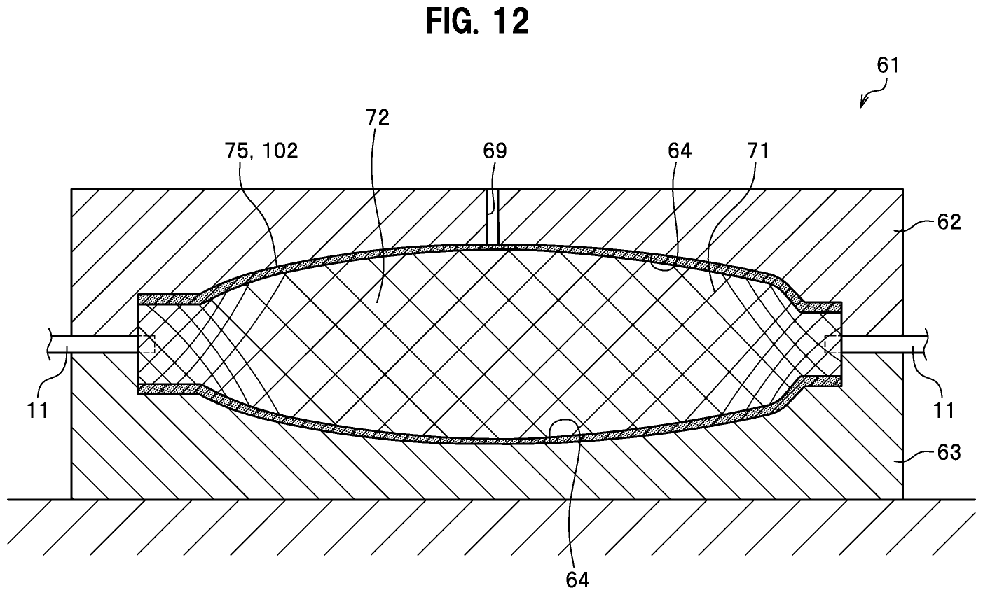

In the bulging step (step S12), a fluid is supplied from a heating device via the supply pipe 11 into the bulging body 72. The fluid is supplied to the extent that the bulging body 72 bulges to have an outer periphery of the bulging body 72 contacting the cavity surfaces 64 (see FIG. 12). Note that windings of the fiber 71 wound around the bulging body 72 define gaps therebetween, and the gaps are enlarged in the bulging step. Thus, the gaps define a flow channel through which the resin flows in the supplying step to follow. In addition, the temperature of the fluid is set to one at which the resin is not cured in the supplying step.

<Supplying Step>

In the supplying step (step S13), the uncured resin is supplied into the mold 61 through the spool 69. Accordingly, the resin flows through the gaps between the windings of the fiber 71, to form a resin body 75 in a cylindrical shape between the outer periphery of the bulging body 72 and the cavity surfaces 64, as shown in FIG. 12.

<Curing Step>

In the curing step (step S14), the fluid in the bulging body 72 is discharged through one of the two supply pipes 11 while the high temperature fluid is supplied into the bulging body 72 through the other supply pipe 11. Here, the temperature of the fluid to be supplied is set to one at which the resin can be cured (e.g., 130° to) 180°. According to the step, the resin body 75 is cured to form the tube body 102 made of fiber-reinforced resin.

<Removing Step>

The removing step (step S15) recovers the liquid in the bulging body 72. This causes the bulging body 72 to have the pressure therein decreased and to be restored to the original shape of a cylinder. Next, the mold 61 is opened and the bulging body 72 is removed from the tube body 102, to finish the tube body 102.

As described above, according to the fourth embodiment, the tube body 102 in a so-called barrel shape is manufactured without using any core material.

Hereinabove, the embodiments have been described, but the present invention is not limited thereto. For example, connection-portion mold areas (the first-connection-portion mold area 5 and second-connection-portion mold area 8) of the cavity surface of the mold, which form connection portions (the first and second connection portions 120, 130) to connect with the stub yoke 103 or stub shaft 104, may have a cross section in a polygonal shape. This causes the first and second connection portions 120, 130 to have a cross section formed in a polygonal shape. Accordingly, time and effort required to separately form the first and second connection portions 120, 130 into polygonal shapes are eliminated.

In addition, the annular member 53 is used as an example of restricting the bulging amount of the bulging body, but alternatively a thickness of the bulging body itself may be changed to restrict the bulging amount.

Further, regarding the tube body of the present invention, the cross section of the main body 110, taken along the axis O1, is not limited to have an arc shape. For example, the cross section of the main body 110, taken along the axis O1, may have a stepped shape. That is, the main-body mold area 6 of the cavity surface of the mold may have a cross section, taken along the longitudinal direction, in a stepped shape.

Furthermore, the tube bodies manufactured by the manufacturing methods of the present invention are not limited to those described above. For example, a plate thickness of the inclined portion may gradually decrease from an end closer to the main body (front side) toward an end closer to the second connection portion (rear side). Accordingly, the inclined portion has the smallest plate thickness at a rear end thereof as a weak portion. Alternatively, a recess may circumferentially be formed in an outer or inner periphery of the inclined portion so as to have a plate thickness of the recess partly changed to form a weak portion.

### LEGEND FOR REFERENCE NUMERALS

1, 21, 41, 61 mold; 4, 24, 44, 64 cavity surface; 6, 26, 46, 66 main-body mold area; 10, 30 resin portion; 11 supply pipe; 12, 52, 72 bulging body; 15, 35, 55, 75 resin body; and 101, 201, 301 power transmission shaft.

What is claimed is:

1. A method for manufacturing a tube body made of fiber-reinforced plastic and used in a power transmission shaft, the method comprising:
a generating step of disposing an uncured fiber-reinforced resin on a cavity surface of a mold and generating a resin body in a cylindrical shape; and
a curing step of supplying a fluid inside the resin body and curing the resin of the resin body
wherein the cavity surface of the mold has a main-body mold area to mold a main body of the tube body,
the main-body mold area has a diameter thereof gradually decreasing from a central portion thereof toward both ends in a longitudinal direction thereof, and
the fiber-reinforced plastic is disposed in the generation step so that the power transmission shaft has the number of layers of the fiber-reinforced plastic decreased from both ends in a longitudinal direction thereof toward a central portion thereof.

2. The method for manufacturing a tube body as claimed in claim 1, wherein
the generating step involves disposing a bulging body in the resin body, and
the curing step involves supplying the fluid, having a temperature at which the resin body is cured, into the bulging body so that the bulging body bulges to contact the resin body.

3. A method for manufacturing a tube body made of fiber-reinforced plastic and used in a power transmission shaft, the method comprising:
a preparing step of disposing a cylindrical bulging body having a fiber wound therearound in a mold;
a bulging step of supplying a fluid into the bulging body to bulge the bulging body having the fiber wound therearound;
a supplying step of supplying uncured resin within the mold;
a curing step of curing the uncured resin; and
a removing step of discharging the fluid to cause the bulging body to restore an original cylindrical shape, and removing the bulging body from the tube body.

4. The method for manufacturing a tube body as claimed in claim 1, wherein the curing step involves heating the mold.

5. The method for manufacturing a tube body as claimed in claim 3, wherein
a cavity surface of the mold has a main-body mold area to mold a main body of the tube body,
wherein the main-body mold area has a diameter thereof gradually decreasing from a central portion thereof toward both ends in a longitudinal direction thereof.

6. The method for manufacturing a tube body as claimed in claim 3, wherein
a cavity surface of the mold has a main-body mold area to mold a main body of the tube body,
wherein the main-body mold area has a diameter thereof gradually decreasing from a central portion thereof toward one end in a longitudinal direction thereof, while having a constant diameter from the central potion to the other end in the longitudinal direction thereof.

7. The method for manufacturing a tube body as claimed in claim 3, wherein
a cavity surface of the mold has a main-body mold area to mold a main body of the tube body,
wherein the main-body mold area has a constant diameter from one end to the other end in the longitudinal direction thereof.

8. The method for manufacturing a tube body as claimed in claim 1, wherein
a cavity surface of the mold has a connection-portion mold area to mold a connection portion of the tube body,
wherein the connection-portion mold area has a cross section in a polygonal shape.

9. The method for manufacturing a tube body as claimed in claim 2, wherein the curing step involves heating the mold.

10. The method for manufacturing a tube body as claimed in claim 2, wherein
a cavity surface of the mold has a connection-portion mold area to mold a connection portion of the tube body,
wherein the connection-portion mold area has a cross section in a polygonal shape.

11. The method for manufacturing a tube body as claimed in claim 3, wherein
the curing step involves heating the mold.

12. The method for manufacturing a tube body as claimed in claim 3, wherein
a cavity surface of the mold has a connection-portion mold area to mold a connection portion of the tube body,
wherein the connection-portion mold area has a cross section in a polygonal shape.

13. The method for manufacturing a tube body as claimed in claim 4, wherein
a cavity surface of the mold has a main-body mold area to mold a main body of the tube body,
wherein the main-body mold area has a diameter thereof gradually decreasing from a central portion thereof toward both ends in a longitudinal direction thereof.

14. The method for manufacturing a tube body as claimed in claim 4, wherein
a cavity surface of the mold has a main-body mold area to mold a main body of the tube body,
wherein the main-body mold area has a diameter thereof gradually decreasing from a central portion thereof toward one end in a longitudinal direction thereof, while having a constant diameter from the central potion to the other end in the longitudinal direction thereof.

15. The method for manufacturing a tube body as claimed in claim 4, wherein
a cavity surface of the mold has a main-body mold area to mold a main body of the tube body,
wherein the main-body mold area has a constant diameter from one end to the other end in the longitudinal direction thereof.

16. The method for manufacturing a tube body as claimed in claim 4, wherein
a cavity surface of the mold has a connection-portion mold area to mold a connection portion of the tube body,
wherein the connection-portion mold area has a cross section in a polygonal shape.

17. The method for manufacturing a tube body as claimed in claim 9, wherein
a cavity surface of the mold has a main-body mold area to mold a main body of the tube body,
wherein the main-body mold area has a diameter thereof gradually decreasing from a central portion thereof toward both ends in a longitudinal direction thereof.

18. The method for manufacturing a tube body as claimed in claim 11, wherein
a cavity surface of the mold has a main-body mold area to mold a main body of the tube body,
wherein the main-body mold area has a diameter thereof gradually decreasing from a central portion thereof toward both ends in a longitudinal direction thereof.

19. The method for manufacturing a tube body as claimed in claim 9, wherein
a cavity surface of the mold has a main-body mold area to mold a main body of the tube body,
wherein the main-body mold area has a diameter thereof gradually decreasing from a central portion thereof toward one end in a longitudinal direction thereof, while having a constant diameter from the central potion to the other end in the longitudinal direction thereof.

20. The method for manufacturing a tube body as claimed in claim 11, wherein
a cavity surface of the mold has a main-body mold area to mold a main body of the tube body,
wherein the main-body mold area has a diameter thereof gradually decreasing from a central portion thereof toward one end in a longitudinal direction thereof, while having a constant diameter from the central potion to the other end in the longitudinal direction thereof.
